(19) United States
(12) Patent Application Publication
(10) Pub. No.: US 2020/0294410 A1
(43) Pub. Date: Sep. 17, 2020

(54) METHODS, SYSTEMS, APPARATUSES AND DEVICES FOR FACILITATING GRADING OF HANDWRITTEN SHEETS

(71) Applicant: Paul DelBane, Strongsville, OH (US)

(72) Inventor: Paul DelBane, Strongsville, OH (US)

(21) Appl. No.: 16/433,495

(22) Filed: Jun. 6, 2019

Related U.S. Application Data
(60) Provisional application No. 62/818,508, filed on Mar. 14, 2019.

(51) Int. Cl. G09B 7/00; G06N 3/04; G06K 9/62; G06K 9/46; G06F 17/27

(52) U.S. Cl. CPC G09B 7/00; G06N 3/04; G06K 9/6262; G06K 2209/01; G06F 17/2785; G06F 17/271; G06K 9/46

(57) ABSTRACT

A system for facilitating grading of handwritten sheets is disclosed. Accordingly, the system may include a communication device configured for receiving at least one digital answer sheet from at least one student device, receiving at least one digital master sheet from at least one evaluator device, and transmitting at least one grade to at least one of the at least one student device, and the at least one evaluator device, a processing device configured for determining at least one of a student hand-script and an evaluator hand-script based on analysis of the at least one digital answer sheet and digital master sheet respectively, comparing the at least one student hand-script with the at least one evaluator hand-script, and assigning the at least one grade to the at least one digital answer sheet based on the comparing, and a storage device configured for storing the at least one grade.

### RELATED APPLICATION(S)

Under provisions of 35 U.S.C. § 119e, the Applicant(s) claim the benefit of U.S. provisional application No. 62/818,508, titled “SYSTEMS AND METHODS TO FACILITATE AUTOMATIC AND OBJECTIVE GRADING OF HANDWRITTEN SHEETS AND TRACKING OF STUDENT AND TEACHER PROGRESS”, filed on Mar. 14, 2019 which is incorporated herein by reference.

### TECHNICAL FIELD

Generally, the present disclosure relates to the field of data processing. More specifically, the present disclosure relates to methods, systems, apparatuses and devices for facilitating grading of handwritten sheets.

### BACKGROUND

In order to grade students' answer sheets, teachers usually spend a considerable amount of time. Teachers spend hours, after school, hand grading student papers. If a teacher has (for example) 20 students (low count) and five subjects (also low count), that would be 100 papers. At one minute per paper (average), that is 1.5 hours of just plain grading paperwork.

Further, each student has a unique style of writing, making it difficult for existing HCR (Handwriting Character Recognition) programs to comprehend.

Further, existing grading techniques may only allow grading of pre-selected or structured test papers (such as tick boxes, Bubble forms, etc.) instead of grading “any” form of test paper (e.g. workbook, freeform, or individual teacher created form).

Further, subjective grading is a major concern in education field. Ideally, grading should be objective rather than subjective. In a fair grading process, a student should be graded solely based on the content written in his/her answer sheet and should not be based on other factors such as emotions, errors, etc. Further, in some cases, subjective grading can lead to widespread student failure. Further, information for subjective grading may be available on multiple websites (such as: https://www.cleveland.com/nation/index.ssf/2009/10/grading_of_students_too_subjec.html).

Further, no current grading system provides real-time tracking of progress associated with students and teachers. Such progress tracking techniques may assist students to improve their study skills. Further, such progress tracking techniques may assist teachers to improve their teaching skills. Also, such progress tracking techniques will allow schools (individual and/or districts) to analyze teacher performance at any given time period. Progressing from this would be comparison through entire education system.

Therefore, there is a need for improved methods, systems, apparatuses and devices for facilitating grading of handwritten sheets that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating grading of handwritten sheets, in accordance with some embodiments. Accordingly, the method may include receiving, using a communication device, at least one digital answer sheet associated with at least one student from at least one student device. Further, the method may include receiving, using the communication device, at least one digital master sheet associated with at least one evaluator from at least one evaluator device. Further, the method may include determining, using a processing device, at least one student hand-script based on analysis of the at least one digital answer sheet. Further, the method may include determining, using the processing device, at least one evaluator hand-script based on analysis of the at least one digital master sheet. Further, the method may include comparing, using the processing device, the at least one student hand-script with the at least one evaluator hand-script. Further, the method may include assigning, using the processing device, at least one grade to the at least one digital answer sheet based on the comparing. Further, the method may include storing, using a storage device, the at least one grade. Further, the method may include transmitting, using the communication device, the at least one grade to at least one of the at least one student device, and the at least one evaluator device.

Further disclosed herein is a system for facilitating grading of handwritten sheets, in accordance with some embodiments. Accordingly, the system may include a communication device configured for receiving at least one digital answer sheet associated with at least one student from at least one student device. Further, the communication device may be configured for receiving at least one digital master sheet associated with at least one evaluator from at least one evaluator device. Further, the communication device may be configured for transmitting at least one grade to at least one of the at least one student device, and the at least one evaluator device. Further, the system may include a processing device configured for determining at least one student hand-script based on analysis of the at least one digital answer sheet. Further, the processing device may be configured for determining at least one evaluator hand-script based on analysis of the at least one digital master sheet. Further, the processing device may be configured for comparing the at least one student hand-script with the at least one evaluator hand-script. Further, the processing device may be configured for assigning the at least one grade to the at least one digital answer sheet based on the comparing. Further, the system may include a storage device configured for storing the at least one grade.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram representation of a system for facilitating grading of handwritten sheets, in accordance with some embodiments.

FIG. 3 is a flowchart of a method for facilitating grading of handwritten sheets, in accordance with some embodiments.

FIG. 4 is a flowchart of a method to facilitate analysis of at least one of at least one digital master sheet and at least one digital answer sheet, in accordance with some embodiments.

FIG. 5 is a flowchart of a method to facilitate obtaining performance trends for students and evaluators, in accordance with some embodiments.

FIG. 6 is a flowchart of a method to facilitate automatic and objective grading of handwritten sheets, in accordance with some embodiments.

FIG. 7 is a flowchart of a method to facilitate automatic and objective grading of handwritten sheets, in accordance with another embodiment.

FIG. 8 is a flowchart of a method to automate generating objective performance trend for teachers and/or students, in accordance with some embodiments.

FIG. 9 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of grading of handwritten sheets, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure, in an instance, may include systems and methods to facilitate automatic and objective grading of handwritten sheets. Accordingly, the handwritten sheets, in an instance, may be sheets that may include handwritten and/or hand-drawn content which may be written and/or drawn by a user (such as a student, a candidate, an assessor, and/or a teacher, etc.). For instance, the handwritten sheet may include (but not limited to) an answer sheet submitted by a student. Further, the answer sheet, in an instance, may include handwritten and/or hand-drawn content such as (but not limited to) textual handwritten content, and/or non-textual visual content (such as hand-drawn sketches/drawing), etc. Further, the handwritten sheets may be stacked in any order and/or may be scanned in any available machine. Further, a scanned file (“.pdf” file) may be transmitted to teacher's computer device. Further, in some embodiments, the system and method to facilitate automatic grading handwritten sheets, in an instance, may be configured to take any workbook page (Free Form). For instance, no pre-existing knowledge (database or on-line) may be needed. Further, in some embodiments, the teacher may make up their own free form test/quiz.

Further, the present disclosure, in an instance, may offer accurate, precise and timely feedback to the students and teachers that may be aimed at helping students and teachers improve.

Further, in some embodiments, the system, in an instance, may be configured to receive a “.pdf” file (drag and drop input) and may output a calculated grade. Further, the “.pdf” file, in an instance, may include a plurality of pages that may have some form of order (such as a first page, a second page, and/or remaining pages, etc.). For instance, a first page associated with the “.pdf” file, in an instance, may be an original worksheet (and/or may be referred to as an unmarked worksheet). For instance, the unmarked worksheet may include (but not limited to) tests, quizzes, busy work, etc. Further, the second page, in an instance, may be a marked worksheet (and/or may be referred to as teacher's marked worksheet). Further, the marked worksheet, in an instance, may be used as “correct” marks to grade successive student worksheets (in any order). Further, the remaining pages, in an instance, may be students' worksheets. Further, in one embodiment, the worksheets may be bubble form, form with prepositioned answer grids or online form/worksheet, etc., where the computing device may find answer and/or the computing device may know the answer. Further, in some embodiments, the worksheet may be a free-form paperwork, where the computing device may come up with answers and/or may then use the answers to grade/compute final grade.

Further, the method may include converting the “.pdf” file to an image file for processing. Accordingly, a paperwork, in an instance, may be scanned and may be sent as the “.pdf” file to a desktop. Further, the desktop, in an instance, may include a grading icon for grading the handwritten sheets. Further, the “.pdf” file, in an instance, may be drag-and-dropped onto the grading icon. Further, the method may include converting the “.pdf” file into image files for processing.

Further, the method may include separating and/or extracting markings from the paperwork. Further, the processing may first compare the unmarked worksheet, original worksheet, to the remaining sheets on a one-by-one basis. Further, differences between the images, in an instance, may result in extracted markings. Further, the extracted markings, in an instance, may be textual handwritten answers, and/or non-textual visual content (such as hand-drawn sketches/drawing) to the worksheet (including names). Further, the processing now eliminates the first (and/or unmarked, original worksheet).

Further, the method may include converting extract markings into letters then words (and/or abstract lines to sketches/drawings). Further, a computer, in an instance, may look at each page (extracted markings). Further, the processing now converts the extracted markings into machine-readable characters. To elaborate, the extracted markings (at this point), in an instance, may be just images/dots in a computer memory. The method may convert the images into single letters (characters) and may then group the individual characters into words.

Further, the method may include comparing teacher paper (correct answers) to each student paper. Accordingly, in one embodiment, the second page, the teacher (correct answers), may now be compared against the remaining pages (such as the student's papers). Further, the comparing, in an instance, may include either a match (correct) and/or not (incorrect). Further, in some embodiments, the method may include determining the number of original worksheets and/or if the original worksheet is single sided or double sided and grade (analyze) accordingly.

Further, the method may include a step of print out of student grade.

Further, the step, in an instance, may count the correct and incorrect markings and/or may print a sheet with the student name and the resulting grade.

Further, the method may include placing correct marks on to student papers by bounding boxes. Further, the bounding boxes, in an instance, may not be visible to users in final output.

Further, the method may include recompiling of pages (currently in image format) into “.pdf” format.

Further, the paperwork, in an instance, may be in computer memory as image files. The method may include a step of converting images back into pages and places a “.pdf” file on to the desktop. Further, the “.pdf” file, in an instance, may include the teacher paper, student papers and a grade paper (with student name and respective grade). Further, the teacher, in an instance, may review each student paper on an as needed basis. Further, the grade may be exported to already existing school programs such as (but not limited to) LearnBoost, ThinkWare, EnGrade, PraxiSchool, etc.

Further, in some embodiments, the teacher may hand out assignments (paperwork) and may then gather the paperwork for grading. In one embodiment, a method may start with the teacher using any existing (school supplied) worksheets. Further, in another embodiment, the teacher may make up their own free form test/quiz. Further, the school supplied worksheets, in an instance, may be single-sided and/or double-sided or multiple pages. For instance, the teacher may gather all the student's papers (student paper). Further, the teacher may themselves, fill out one test/quiz (teacher paper). Further, the teacher paper may be referred to as a master answer sheet. Further, one other paper needed is one copy of the quiz/test (original paper).

Further, the teacher may gather the papers and places them in exact order, i.e. original paper, then teacher paper, then student papers (in any order). Further, the teacher may use any form of scanner (ex. copy machine at the school) and may scan a stack of papers into a single “.pdf” file. Further, the “.pdf” file, in an instance, may be sent to a computing device associated with the teacher.

Further, the “.pdf” file may now be placed into a program. Further, the program, in an instance, may use a drag-and-drop GUI (GUI=Graphical user interface). On the computing device, there may be an icon for the program. The “.pdf” file may be moved over the icon and when dropped, the program may run.

Further, the program may convert the “.pdf” file into single page images to process the paperwork. Further, the computing device, in an instance, may create a folder called “images” which contains original input pages converted to .png format and these images are the input of processing part.

Further, the method may include comparing pages to extract markings (in order to isolate the individual letters/words/sentences). For instance, the program may compare page 1 (such as the original paper) with page 2 (such as the teacher paper). Further, the program may subtract original image (background) from teacher image and may leave only markings (or pixels) that may be referred to as teacher marks. Further, the teacher marks may be assumed to be correct marks.

Further, the program may then compare page 1 (original paper) with the teacher paper and with each student paper, one at a time, removing the original image (background) from the teacher paper and from each student paper leaving only the teacher marks and student marks (e.g. answers from the teacher and student).

Further, at this stage, the program may basically erase the background from the teacher paper and the student paper leaving the marks behind. For instance, the marks have been extracted or isolated.

Further, the method, in an instance, may exploit fact that handwritten letters differ in the intensity compared to printed letters. Further, simple page subtraction generates significant noise components. Tested several approaches and implemented the one based on histogram differencing to find gray level of the marks. Further, the program may create a folder called “markingImages” which may contain processed images which may show extracted markings. Further, the program, in an instance, may include a page alignment algorithm in marking extractor portion. Further, the program, in an instance, may include combining more complex thresholding, page differencing on block level and noise removal. Further, morphological processing may effectively enlarge the pixel size and then calculate the difference between pages to increase accuracy.

Further, the program, in an instance, may use “bounding boxes” to keep the markings grouped. At this point, the marks may still be pixels in the computer memory. Further, the “bounding boxes” may keep the words grouped. This step may be needed during further processing. For instance, a word “Cat” may be considered in a bounding box. If the word was not, further processing may result in “C”+“at”. Both would be correct as an answer, but when looking for “Cat”, “C”+“at” may not be correct. In the computer memory, each letter (if answer sheet is single letter answer) or word (word answer or sentence answer) is now in its own box. For instance, if an answer is “the mouse fell,” then the bounding boxes on an initial extraction would already be around [the], [mouse], [fell] and a recognizer putting the words together would know that three characters may be grouped for the first word (“the”), five for the second string (“mouse”) and so on. Further, the bounding boxes, in an instance, may be important to remember where to place a returned word (position and size). Further, the position and size may be retained.

Further, the bounding boxes, in an instance, may be used to retain position and size of student and teacher marks. For instance, for quizzes such as “Circle the correct answer,” a correct answer may be circled which would be similar to letter “O”, but bigger in size. Accordingly, the program may compare the position and size of the teacher “O” to the student “O”. If position corresponding to the teacher marking (“O”) and the student marking (“O”) are the same (within pre-programmed tolerances), then correct. Further, if answer is wrong, the program may place the correct answer in a correct position on the student paper. For example, if teacher/correct answer is “Cat” and if student answer is “Dog”, then the program already has the bounding box in the position where found “dog”. Further, the program, in an instance, may then use teacher bounding box position and size, place this on student paper and place “Cat” (the correct answer) on the student paper in the correct position.

Further, the program may now segment each extracted page. For instance, the program may turn the marks into single images for further processing. For example, the word “cat”, at this point, is only a grouping of pixels (or dots) in the computer memory (inside a bounding box). Further, the word “Cat” may not be understandable yet. Further, the program may segment the remaining images (teacher and student markings) and may isolate the image pieces into individual characters. For example, “cat” may still be a group of pixels or dots, but now “Cat” may be broken down to individual characters and may become “c” and “a” and “t”. Further, segmented pages, in an instance, may be shown in a separate window with buttons previous/next image.

Further, the method may include a step of recognition of markings. Further, this step may turn the pixels into characters (individual letters and numbers). Further, in some embodiments, the program may use a simpler CNN model for both training and/or tracking. Further, the CNN model may be referred to as “convolutional neural networks”. Further, the CNN model is widely used for image recognition.

In some embodiments, the method may include training and/or performance evaluation of the system configured for performing the step of analyzing/recognizing the handwritten content based on a database of handwriting content.

Further, in one embodiment, the program may be only used for letters (with training and database). Further, in other embodiments, the program may be used for digits and/or numbers (with duplicate, change database). Further, the program, in an instance, may decrease recognition errors (and/or may increase recognition accuracy). Further, in some embodiments, the program may add a selection of math mode (only numbers) and spelling mode (only letters) to the GUI.

Further, the program, in an instance, may include morphological processing to connect some broken character parts that may result in improved recognition.

Further, the training of the system, in an instance, may be an ongoing process. The training, in an instance, may be a process where parameters of neural network may be adjusted using known sample pairs image-letter. For example, for an input of the image of letter A in the neural network, the parameters may be adjusted so that output of network may give the label ‘A’. For each training image, the parameters may be adjusted. Further, the neural network, in an instance, may learn to recognize letter from the input image based on the training. Further, once the training may be finished, the neural network may be used to recognize new character images that may be segmented from the “.pdf”.

Further, in some embodiments, for a case of connected characters, the program may be configured to recognize handwritten characters in a sliding window manner where the program may move with “window image” on a word from left to the right and perform multiple recognitions. Further, the multiple recognition may result in unknown characters, repeatedly, until a known character may be recognized (then stop and move to next character).

Further, in some embodiments, an additional processing step may be added to remove extra lines from character boundaries since the extra lines under and/or around some characters may interfere with recognition.

Further, in some embodiments, the method may include an additional processing step to check neighboring characters in order to restore letter “I” as the letter “I” may sometimes be removed by the algorithm because the algorithm may identify too narrow components (such as letter “I”) as noise components (too narrow components are removed). For instance, the program may check neighboring components and if the neighboring components are valid characters, narrow component “I” may be restored.

Further, the method may include a step of turning the letters (and/or characters) into words. Further, the program may use the bounding boxes. For instance, individual characters “c”+“a”+“t” may be placed back into the bounding box. Further, the individual characters may be added together and may become a “string” (computer terminology for a word). Further, in some embodiments, the program may be configured to turn the individual words into sentences.

Further, the method may include a step of grading papers. Accordingly, all pages, in an instance, may be compared with the second page (teacher marked worksheet) and percentage of “correct” words may be calculated. For instance, the second page (and/or Sheet 2 based on original “.pdf” file) may be equated with 100%, and/or the following sheets may be a percentage based on a similarity with the second page. Further, “Correct” words, in an instance, may be words recognized in the second page (and/or teacher's page). Further, “Wrong” words, in an instance, may be bounded with red rectangles. Further, in some embodiments, the program may use the red rectangles to fill in “correct” words and/or answers. Further, a graded “.pdf” file may be printed by the teacher, which may be handed out to the student and may include the “correct” answer to the question.

Further, in some embodiments, the recognition may be improved with more exhaustive training (and/or more training samples) and with a dictionary-based approach where recognition results may be compared with a set of possible words (from a dictionary).

Further, the method may include a step of generating output. Further, the output, in an instance, may be a “.pdf” file with old image returned with new recognized characters. Further, the output “.pdf” file, in an instance, may include a (new) last page (and/or a Grade Page). Further, the grade page, in an instance, may be a simplistic listing of student names (in order of pages presented, or sorted alphabetically) and an objective grade based on % of words (and/or answers) correctly matched. Further, the grade page, in an instance, may be added as the last page in output “.pdf” saved on the computing device. Further, the program, in an instance, may return the papers in the order scanned initially (i.e., the teacher page as a first page and so on). Further, the output “.pdf” file, in an instance, may be referred to as “OutputRecognizedMarked”.

Further, in some embodiments, the method may include a step of retraining more complex classifier (neural network with more layers) in order to improve results as handwriting recognition is more challenging than printed text, especially when case sensitive letters may be used. Further, retraining more complex classifier (neural network with more layers) may improve results (and/or recognition accuracy).

Further, in some embodiments, the system may be trained with more samples, thereby, adding more layers to the neural network for recognition improvement. Further, separate lowercase and uppercase recognizers, in an instance, may achieve greater accuracy compared with single recognizer for upper and lowercase letters.

Further, in some embodiments, the system may be configured to perform multiple recognition of the same character with different border widths to strengthen a final estimation.

Further, in some embodiments, the program may be configured to use multiple recognition approaches, single times, on one character, then comparing results. Further, such an approach, in an instance, may increase accuracy.

Further, in some embodiments, multiple recognitions may combine existing classifier with another one like SVM (support vector machines). Further, multiple CNN classifiers may be used to improve results. For instance, for case sensitive letters obtained accuracy may be about 80%. Further, by using multiple methods single time or single method multiple times, the accuracy goes (for instance) from 75% to 90%.

Further, in some embodiments, the CNN (convolutional neural network) may outperform SVM classifier when large training dataset may be used at an expense of computational load during training and usage. Further, the SVM, in an instance, may be trained much faster and may be executed faster as well, but the accuracy may be lower than the convolutional neural network. Further, the SVM, in an instance, may be useful in the case of multiple recognitions approach.

Further, in some embodiments, matching aspect of the program was to have the program may analyze the teacher page and turn the markings corresponding to the teacher page into correct words. For instance, the program may analyze the teacher page, turn extracted markings into letters, then words and then build a temporary database of words from the teacher page. Further, the temporary database of words from the teacher page may then be used to grade the student papers. Further, in some embodiments, the program may look at complete analysis of teacher page, turn into words, and then look at all the student papers, then use the temporary database of words (from the teacher page) to then grade student papers.

Further, in some embodiments, the system and method to facilitate automatic grading of handwritten sheets, in an instance, may allow the teachers to make their own test/quiz paper and not have to use predetermined, structured form. For instance, the teacher could make up own quiz and may not have to follow structure provided by text books or schools. This can be unique to the school/teacher or be some form of improvement on existing work.

Further, in some embodiments, a trend may be shown where missed answers may be related to the student's books to show a presented concept is not fully developed in the book and may need to be re-written.

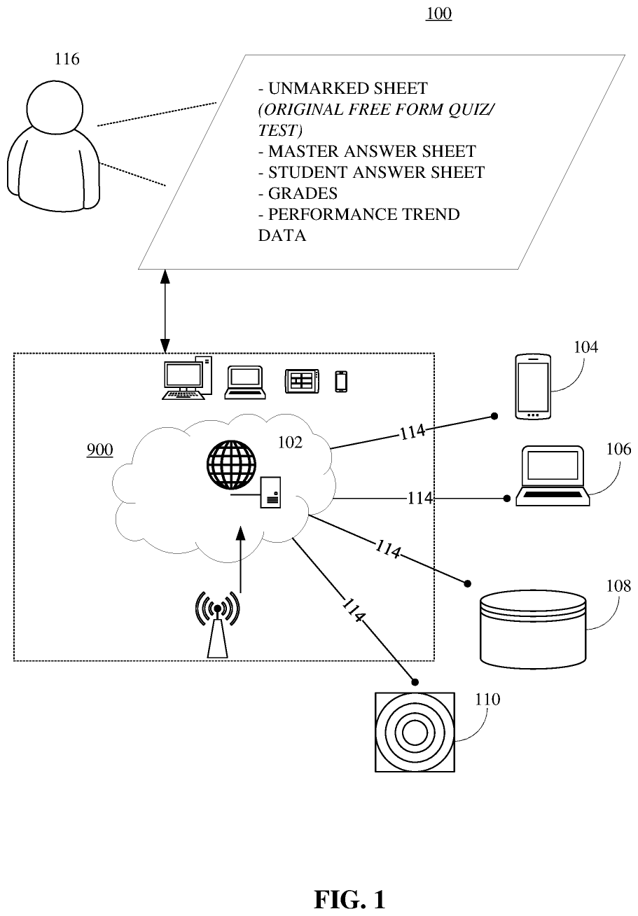

FIG. 1 is an illustration of an online platform 100 consistent with various embodiments of the present disclosure. By way of non-limiting example, the online platform 100 to facilitate grading of handwritten sheets may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 900.

Further, the online platform 100 may be configured to facilitate automatic and objective grading of handwritten sheets. Accordingly, the handwritten sheets, in an instance, may be sheets that may include handwritten and/or hand-drawn content, which may be written and/or drawn by the user. For instance, the handwritten sheet may include (but not limited to) an answer sheet submitted by a student. Further, the answer sheet, in an instance, may include handwritten and/or hand-drawn content such as (but not limited to) textual handwritten content, and/or non-textual visual content (such as hand-drawn sketches/drawing), etc.

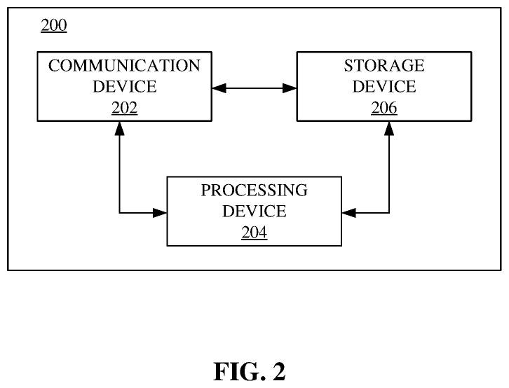

FIG. 2 is a block diagram representation of a system 200 for facilitating grading of handwritten sheets, in accordance with some embodiments. Accordingly, the system 200 may include a communication device 202 configured for receiving at least one digital answer sheet associated with at least one student from at least one student device. Further, the at least one digital answer sheet may be a digital representation of a student answer sheet. Further, the student answer sheet may be marked by the at least one student. Further, the at least one student device, in an instance, may be a user device that may be operated by the at least one student in order to provide the digital answer sheet (for e.g. by scanning a sheet through a camera sensor that may be embedded within the at least one student device) to the online platform 100. For instance, the at least one student device may include (but not limited to) a smartphone, a smartwatch, a laptop, a PC, and so on.

Further, the communication device 202 may be configured for receiving at least one digital master sheet associated with at least one evaluator from at least one evaluator device. Further, the at least one digital master sheet may be a digital representation of a correctly marked answer sheet. Further, the correctly marked answer sheet may be marked by the at least one evaluator. Further, the at least one evaluator device, in an instance, may be a user device that may be operated by the at least one evaluator (e.g. a teacher) in order to provide the digital master sheet (for e.g. by scanning a sheet through a camera sensor that may be embedded within the at least one evaluator device) to the system 200. For instance, the at least one evaluator device may include (but not limited to) a smartphone, a smartwatch, a laptop, a PC, and so on.

Further, the communication device 202 may be configured for transmitting at least one grade to at least one of the at least one student device, and the at least one evaluator device. Further, the at least one grade, in an instance, may be an objective grade, numerical or alphabetical, based on an extent of correctness (e.g. depending on a number of errors, kind of errors, etc. within an answer associated with the at least one digital answer sheet).

Further, the system 200 may include a processing device 204 configured for determining at least one student hand-script based on analysis of the at least one digital answer sheet.

Further, the processing device 204 may be configured for determining at least one evaluator hand-script based on analysis of the at least one digital master sheet.

Further, the processing device 204 may be configured for comparing the at least one student hand-script with the at least one evaluator hand-script.

Further, the processing device 204 may be configured for assigning the at least one grade to the at least one digital answer sheet based on the comparing.

Further, the system 200 may include a storage device 206 configured for storing the at least one grade.

In some embodiments, the storage device 206 may be further configured for retrieving a digital template from a database. Further, the digital template may be a digital representation of unmarked templates associated with at least one question paper. Further, the processing device 204 may be configured for comparing the at least one digital master sheet with the digital template to determine the at least one evaluator hand-script (sometimes may be referred to as a teacher hand-script). For instance, the processing device 204 may compare the at least one digital master sheet with the digital template to remove an original image (e.g. background) from the at least one digital master sheet leaving only the at least one evaluator hand-script (and/or markings by an evaluator). Further, the processing device 204 may be configured for comparing the at least one digital answer sheet with the digital template to determine the at least one student hand-script. For instance, the processing device 204 may compare the at least one digital answer sheet with the digital template to remove an original image (e.g. background) from the at least one digital answer sheet leaving only the at least one student hand-script (and/or markings by a student).

In some embodiments, the processing device 204 may be further configured for performing a textual analysis on at least one of the at least one evaluator hand-script and the at least one student hand-script using convolutional neural network for handwritten content. Further, in some embodiments, the textual analysis may include at least one of semantic analysis, syntactic analysis, and Intelligent Character Recognition. Further, in some embodiment, the textual analysis may include analysis using bounding boxes.

In some embodiments, the processing device 204 may be further configured for performing non-textual visual analysis on the at least one evaluator hand-script and the at least one student hand-script using convolutional neural network for non-textual visual content. For instance, the non-textual visual content may include but not limited to a hand-drawn sketch, a shape, and so on. Further, in some embodiments, the non-textual visual analysis may include object recognition.

In some embodiments, the processing device 204 may be further configured for generating performance trend data associated with at least one of the at least one student and the at least one evaluator based on the at least one grade. Further, the communication device 202 may be configured for transmitting the performance trend data to at least one of the at least one student device and the at least one evaluator device. Further, in some embodiments, the performance trend data may be a visual representation of the at least one grade associated with the at least one student for at least one subject taught by the at least one evaluator.

In some embodiments, the processing device 204 may be further configured for analyzing the at least one digital answer sheet to extract student data corresponding to the at least one student. Further, the student data may include at least one of a student name, a student identity number, a student roll number, and a student standard. Further, in some embodiments, the transmitting of the at least one grade to at least one of the at least one student device and the at least one evaluator device may be based on the student data.

Further, in some embodiments, the communication device 202 may be configured for receiving a scanned digital document from the at least one evaluator device. Further, the scanned digital document may include each of the at least one digital answer sheets, the at least one digital master sheet, and the digital template. Further, digital sheets (such as the at least one digital answer sheets, the at least one digital master sheet, and the digital template) in the scanned digital document, in an instance, may not be arranged in a predefined order. For instance, the predefined order may include the digital sheets to be piled in an order such as the digital template may come first, the at least one evaluator sheet may be stacked after the digital template, and the at least one digital answer sheet may be stacked later. Further, the processing device 204 may be configured for analyzing the at least one digital master sheet to an extract evaluator data corresponding to the at least one evaluator. Further, the evaluator data, in an instance, may include (but not limited to) an evaluator name, an evaluator identity number, an evaluator designation, and so on. Further, the processing device 204 may be configured for determining the at least one digital master sheet based on the evaluator data. Further, the processing device 204 may be configured for determining the at least one digital answer sheet based on the student data. Further, the processing device 204 may be configured for rearranging the digital sheets in the predefined order based on the determining of the at least one digital answer sheet and the at least one digital master sheet.

Further, in some embodiments, a system 200 may be configured for facilitating grading of handwritten sheets. Further, the handwritten sheets, in an instance, may be sheets that may include handwritten and/or hand-drawn content, which may be written and/or drawn by a candidate, and/or an assessor. Further, the system 200 may include a communication device configured for receiving at least one digital candidate sheet associated with at least one candidate from at least one candidate device. Further, the at least one digital candidate sheet may be a digital representation of a candidate response sheet marked by the at least one candidate. Further, the at least one candidate, in an instance, may be an individual that may provide handwritten response on the candidate response sheet that may need to be graded. For instance, the at least one candidate may include, but not limited to, an applicant that may be applying for a job/position in a hiring firm. Further, the communication device may be configured for receiving at least one digital assessor sheet associated with at least one assessor from at least one assessor device. Further, the at least one digital assessor sheet may be a digital representation of a correctly marked sheet. Further, the correctly marked sheet may be marked by the at least one assessor. Further, the communication device may be configured for transmitting at least one grade to at least one of the at least one candidate device, and the at least one assessor device. Further, the system 200 may include a processing device (such as the processing device 204) configured for determining at least one candidate hand-script based on analysis of the at least one digital candidate sheet. Further, the method may include determining at least one assessor hand-script based on analysis of the at least one digital assessor sheet. Further, the processing device may be configured for comparing the at least one candidate hand-script with the at least one assessor hand-script. Further, the processing device may be configured for assigning the at least one grade to the at least one digital candidate sheet based on the comparing. Further, a storage device (such as the storage device 206) may be configured for storing the at least one grade.

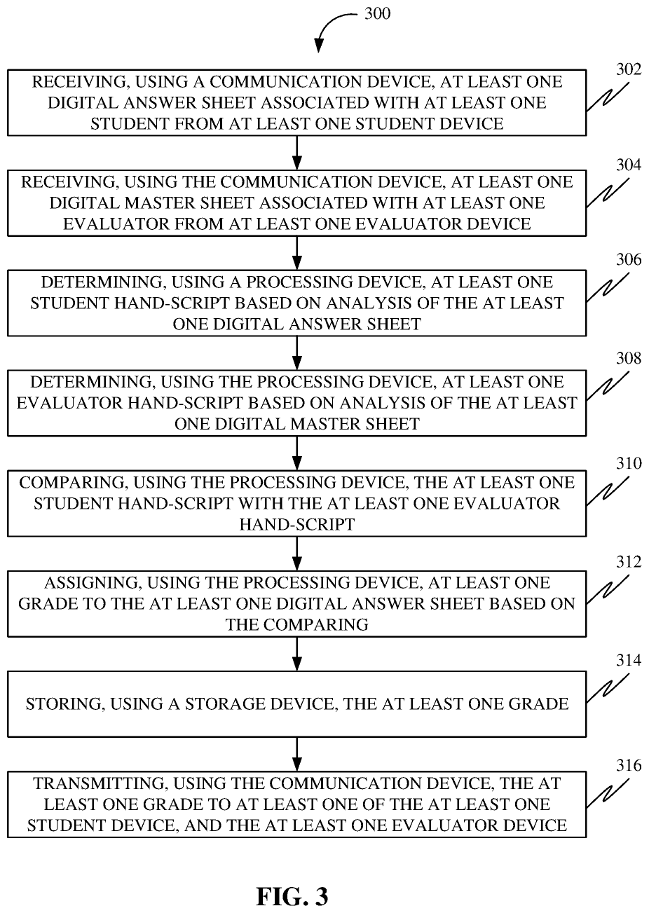

FIG. 3 is a flowchart of a method 300 for facilitating grading of handwritten sheets, in accordance with some embodiments. Accordingly, at 302, the method 300 may include receiving, using a communication device (such as the communication device 202), at least one digital answer sheet associated with at least one student from at least one student device. Further, the at least one digital answer sheet may be a digital representation of a student answer sheet. Further, the student answer sheet may be marked by the at least one student.

Further, at 304, the method 300 may include receiving, using the communication device, at least one digital master sheet associated with at least one evaluator from at least one evaluator device. Further, the at least one digital master sheet may be a digital representation of a correctly marked answer sheet. Further, the correctly marked answer sheet may be marked by the at least one evaluator.

Further, at 306, the method 300 may include determining, using a processing device (such as the processing device 204), at least one student hand-script based on analysis of the at least one digital answer sheet.

Further, at 308, the method 300 may include determining, using the processing device, at least one evaluator hand-script based on analysis of the at least one digital master sheet.

Further, at 310, the method 300 may include comparing, using the processing device, the at least one student hand-script with the at least one evaluator hand-script.

Further, at 312, the method 300 may include assigning, using the processing device, at least one grade to the at least one digital answer sheet based on the comparing.

Further, at 314, the method 300 may include storing, using a storage device (such as the storage device 206), the at least one grade.

Further, at 316, the method 300 may include transmitting, using the communication device, the at least one grade to at least one of the at least one student device, and the at least one evaluator device.

Further, in some embodiments, the method 300 may include performing, using the processing device, a textual analysis on at least one of the at least one evaluator hand-script and the at least one student hand-script using convolutional neural network for handwritten content. Further, in some embodiments, the textual analysis may include at least one of semantic analysis, syntactic analysis, and Intelligent Character Recognition.

Further, in some embodiments, the method 300 may include performing, using the processing device, non-textual visual analysis on the at least one evaluator hand-script and the at least one student hand-script using convolutional neural network for non-textual visual content. For instance, the non-textual visual content may include but not limited to a hand-drawn sketch, a shape, and so on. Further, in some embodiments, the non-textual visual analysis may include object recognition.

Further, in some embodiments, the method 300 may include analyzing, using the processing device, the at least one digital answer sheet to extract student data corresponding to the at least one student. Further, the student data may include at least one of a student name, a student identity number, a student roll number, and a student standard. Further, in some embodiments, the transmitting of the at least one grade to at least one of the at least one student device and the at least one evaluator device may be based on the student data.

Further, in some embodiments, the method 300 may include receiving, using the communication device, a scanned digital document from the at least one evaluator device. Further, the scanned digital document may include each of the at least one digital answer sheets, the at least one digital master sheet, and the digital template. Further, digital sheets (such as the at least one digital answer sheets, the at least one digital master sheet, and the digital template) in the scanned digital document, in an instance, may not be arranged in a predefined order. For instance, the predefined order may include the digital sheets to be piled in an order such as the digital template may come first, the at least one evaluator sheet may be stacked after the digital template, and the at least one digital answer sheet may be stacked later. Further, the method may include analyzing, using the processing device, the at least one digital master sheet to an extract evaluator data corresponding to the at least one evaluator. Further, the evaluator data, in an instance, may include (but not limited to) an evaluator name, an evaluator identity number, an evaluator designation, and so on. Further, the method may include determining, using the processing device, the at least one digital master sheet based on the evaluator data. Further, the method may include determining, using the processing device, the at least one digital answer sheet based on the student data. Further, the method may include rearranging, using the processing device, the digital sheets in the predefined order based on the determining of the at least one digital answer sheet and the at least one digital master sheet.

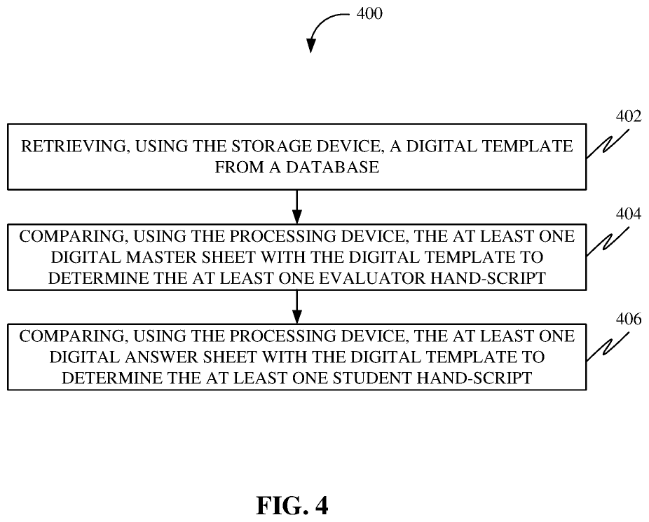

FIG. 4 is a flowchart of a method 400 to facilitate analysis of at least one of the at least one digital master sheet and the at least one digital answer sheet, in accordance with some embodiments. Accordingly, at 402, the method 400 may include retrieving, using the storage device, a digital template from a database. Further, the digital template may be a digital representation of unmarked templates associated with at least one question paper.

Further, at 404, the method 400 may include comparing, using the processing device, the at least one digital master sheet with the digital template to determine the at least one evaluator hand-script.

Further, at 406, the method 400 may include comparing, using the processing device, the at least one digital answer sheet with the digital template to determine the at least one student hand-script.

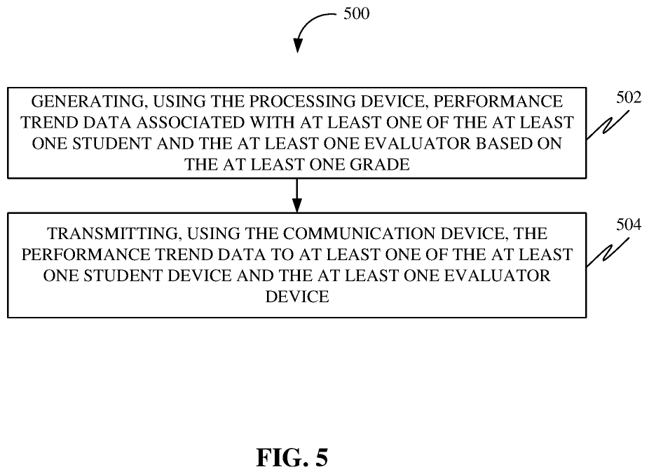

FIG. 5 is a flowchart of a method 500 to facilitate obtaining performance trends for students and evaluators, in accordance with some embodiments. Accordingly, at 502, the method 500 may include generating, using the processing device, performance trend data associated with at least one of the at least one student and the at least one evaluator based on the at least one grade. Further, in some embodiments, the performance trend data may be a visual representation of the at least one grade associated with the at least one student for at least one subject taught by the at least one evaluator.

Further, at 504, the method 500 may include transmitting, using the communication device, the performance trend data to at least one of the at least one student device and the at least one evaluator device.

Further, in some embodiments, a method for facilitating grading of handwritten sheets may include receiving, using a communication device (such as the communication device 202), at least one digital candidate sheet associated with at least one candidate from at least one candidate device. Further, the at least one digital candidate sheet may be a digital representation of a candidate response sheet marked by the at least one candidate. Further, the at least one candidate, in an instance, may be an individual that may provide handwritten response on the candidate response sheet that may need to be graded. For instance, the at least one candidate may include, but not limited to, an applicant that may be applying for a position in a hiring firm. Further, the method may include receiving, using the communication device, at least one digital assessor sheet associated with at least one assessor from at least one assessor device. Further, the at least one digital assessor sheet may be a digital representation of a correctly marked sheet. Further, the correctly marked sheet may be marked by the at least one assessor. Further, the method may include determining, using a processing device (such as the processing device 204), at least one candidate hand-script based on analysis of the at least one digital candidate sheet. Further, the method may include determining, using the processing device, at least one assessor hand-script based on analysis of the at least one digital assessor sheet. Further, the method may include comparing, using the processing device, the at least one candidate hand-script with the at least one assessor hand-script. Further, the method may include assigning, using the processing device, at least one grade to the at least one digital candidate sheet based on the comparing. Further, the method may include storing, using a storage device (such as the storage device 206), the at least one grade. Further, the method may include transmitting, using the communication device, the at least one grade to at least one of the at least one candidate device, and the at least one assessor device.

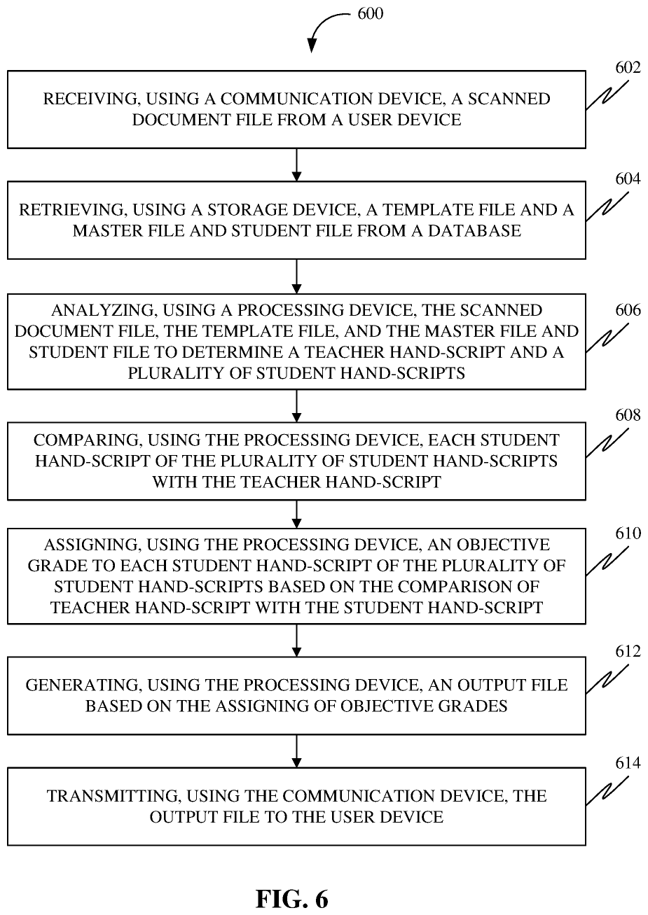

FIG. 6 is a flowchart of a method 600 to facilitate automatic and objective grading of handwritten sheets, in accordance with some embodiments. Accordingly, at 602, the method 600 may include a step of receiving, using a communication device, a scanned document file from a user device. Further, the scanned document file, in an instance, may be a digital file that may include a plurality of student answer sheets in a digital form. For instance, the scanned document file may be a “.pdf” file that may include pages associated with the plurality of student answer sheets. Further, the plurality of student answer sheets, in an instance, may be answer sheets corresponding to a plurality of students, which may need to be graded by a teacher. Further, the plurality of student answer sheets, in an instance, may include (but not limited to) handwritten textual content, and/or hand-drawn visual content (such as hand-drawn sketches/drawing), etc. Further, the plurality of student answer sheets, in an instance, may be physically submitted by the plurality of students to the teacher. Further, the plurality of student answer sheets, in an instance, may be scanned by the teacher through a one or more of sensors that may be embedded within the user device (such as a hardware scanner, and/or a copy machine at school, etc.). For instance, the teacher may use any form of scanner (such as a copy machine) at school and may scan a stack of papers associated with the plurality of student answer sheets in order to generate the scanned document file (such as a “.pdf” file). Further, the one or more sensors may include, but not limited to, light sensors, camera sensors, IR sensors, etc. Further, the user device, in an instance, may be an IoT (Internet of Thing) based device that may be operated by the teacher in order to communicate with the online platform 100. For instance, the user device, in an instance, may include devices such as (but not limited to) smartphones, smartwatches, PCs, laptops, smart TVs, photocopy machines, etc.

Further, at 604, the method 600 may include a step of retrieving, using a storage device, a template file and a master file from a database. Accordingly, the template file, in an instance, may be a digital file that may include a digital representation of a one or more of unmarked sheets. Further, the one or more of unmarked sheets, in an instance, may be templates associated with question papers and/or quizzes that may include questions along with spaces for students to write answers. For instance, the unmarked sheet may include “complete a sentence” type questions providing space for a student to write answer corresponding to each question from available options. Further, in another instance, the unmarked sheet may include “fill in the blanks” type questions for students with a space to write answer corresponding to each question from available vocabulary words. Further, in some embodiments, the unmarked sheet may include one or more section that may provide space for students to provide an information associated with the student. For instance, the information may include (but not limited to) name, roll number, student ID number, etc. associated with the student. Further, the master file, in an instance, may be a digital file that may include a digital representation of one or more master answer sheets. Further, the one or more master answer sheets, in an instance, may be a completely (and/or correctly) marked version of the unmarked sheets when filled with correct answers by the teacher. Further, the one or more master answer sheets, in an instance, may be used by the teacher as a reference in order to grade the plurality of student answer sheets. Further, the template file and the master file, in an instance, may be stored in the database (such as databases 108) by the teacher through the user device. Further, the database, in an instance, may be a storage space that may be configured to store the template file and the master file in an organized form that may be accessed electronically through the user device. Further, the database, in some embodiments, may include any information and/or data that may be required by the online platform 100 in order to implement the method described in the present disclosure.

Further, at 606, the method 600 may include a step of analyzing, using a processing device, the scanned document file, the template file, and the master file to determine a teacher hand-script and a plurality of student hand-scripts. Accordingly, the online platform 100, in an instance, may be configured to analyze the scanned document file, the template file, and the master file in a way such that any handwritten content (that may be referred to as markings) from the plurality of student answer sheets and the one or more master answer sheets may be extracted for grading. For instance, the online platform 100 may be configured to erase a background from the one or more master answer sheets and the plurality of student answer sheets leaving only markings and/or handwritten content behind (such as the teacher hand-script and/or the plurality of student hand-scripts). For instance, the online platform 100 may compare the one or more unmarked sheets (say background) with the one or more master answer sheets (say teacher images) in order to determine the teacher hand-script. The online platform 100, in an instance, may subtract the background from the teacher image and may leave remaining markings (and/or pixels) that may be referred to as the teacher hand-script. The teacher hand-script, in an instance, may be assumed to be correct markings. Further, in another instance, the online platform 100 may compare the one or more unmarked sheets (say original image) with each student answer sheet of the plurality of student answer sheets, one at a time, removing the original image (and/or background) from each student answer sheet leaving only the student hand-script (and/or markings by the student, and/or the answers from the student). Further, the online platform 100, in an instance, may be configured to perform handwriting analyses (that may include processes such as image analyses e.g., but not limited to, Handwritten Character Recognition, Optical Character Recognition, Intelligent word recognition, object recognition, etc.) on the teacher hand-script and the plurality of student hand-scripts. Further, the handwriting analyses, in an instance, may use bounding of words (and/or “bounding boxes”) to keep the markings grouped. For instance, a word (such as “Cat”) may now be considered in a bounding box. If the word “cat” may not be bounded, then further processing may result in two separate words (such as “C”+“at”). Both would be correct as an answer, but when looking for “Cat”, “C”+“at” may not be correct. Further, in another instance, if an answer includes multiple words such as “the mouse fell,” the bounding boxes would already be around [the], [mouse], and [fell]. Further, the online platform 100, in an instance, may know that three characters may be grouped for the first word (the), five for the second string (mouse) and so on. Further, the bounding boxes, in an instance, may be important to remember where to place returned words (position and/or size). Further, the position and size, in an instance, may be retained. Further, once the bounding of words may be performed, the online platform 100 may isolate the markings into individual character images (and/or individual images). For instance, the word “Cat” may now be broken down to individual character images and may become “c,” “a,” and “t.” Further, once the markings may be isolated into individual character images, the online platform 100 may turn pixels into characters by using (for example) a simpler programming model for training and tracking. Further, the CNN model, in an instance, may be a Convolutional Neural Network model that may be widely used for image recognition. Further, in some embodiments, the online platform 100 may be configured to communicate with the other databases such as, but not limited to, NIST special database. Further, the NIST special database was produced by the US government (National Institute of Standards and Technology) for handprint document processing and/or OCR (optical character recognition) research. Further, in some embodiments, the online platform 100 may include morphological processing that may be configured to connect some broken character parts for improved recognition. Further, in some embodiments, the database may include dictionary words that may allow the online platform 100 to analyze the markings with a dictionary-based approach where recognition results may be compared with a set of possible words (from the dictionary).

Further, at 608, the method 600 may include a step of comparing, using the processing device, each student hand-script of the plurality of student hand-scripts with the teacher hand-script. Accordingly, the teacher hand-script and each student hand-script of the plurality of student hand-scripts, in an instance, may be compared by the online platform 100 in order to measure a level of similarity for each student hand-script with the teacher hand-script. Further, the level of similarity, in an instance, may reflect an extent of correctness for each student hand-script. Further, each word and/or markings of each student hand-script, in an instance, may be compared with corresponding word and/or markings of the teacher hand-script in order to measure the level of similarity between the two (the teacher hand-script and each student hand-script).

Further, at 610, the method 600 may include a step of assigning, using the processing device, an objective grade to each student hand-script of the plurality of student hand-scripts based on the comparison of teacher hand-script with the student hand-script. Accordingly, the online platform 100, in an instance, may be configured to assign an objective grade to each student hand-script based on the level of similarity with the teacher hand-script. Further, the objective grade corresponding to each student hand-script, in an instance, may be (but not limited to) a percentage number (%) that may reflect a percentage of “correct” words for each student hand-script. Further, the “correct” words, in an instance, may be words in the student hand-script that may match with corresponding words in the teacher hand-script. For instance, for a student, the objective grade may be 75% which may reflect that the student hand-script (associated with the student) include 75% of the words that may match with the teacher hand-script. Further, in some embodiments, the online platform 100, in an instance, may generate objective grading, numerical or alphabetical, based on the extent of correctness (e.g. depending on a number of errors, kind of errors, etc. within an answer). For instance, the online platform 100 may provide a partial point if at least part of the answer may be correct.

Further, at 612, the method 600 may include a step of generating, using the processing device, an output file based on the assigning of a numerical or alphabetical grade. Accordingly, the output file, in an instance, may be a digital file which may include a grade page. Further, the grade page, in an instance, may be a listing of student names along with the grade corresponding to each student hand-script based on the level of similarity. Further, in some embodiments, the output file may include a sheet for the teacher. Further, the sheet, in an instance, may allow the teacher to see each question along with average score for that question. Further, the sheet, in an instance, may print the top 10% (for instance) questions with lowest aggregate score. Further, the teacher, in an instance, may use the sheet to review the quiz with the students. Further, allowing the teacher to review their own work may show what points in a lesson that were critical (hence, on the quiz) that had the highest lack of understanding. Further, in some embodiments, the output file, in an instance, may include a sheet for the students. The sheet, in an instance, may allow the students to see correct answers to missed questions for further review. For instance, if a student missed a question, the sheet may allow the student to see original (incorrect) answers along with the correct answer corresponding to the question.

Further, at 614, the method 600 may include a step of transmitting, using the communication device, the output file to the user device. Accordingly, the online platform 100, in an instance, may be configured to transmit the output file to the user device through a wireless transmitter. The wireless transmitter, in an instance, may transmit the output file over, but not limited to, a Wi-Fi, a Bluetooth, an electromagnetic waveform, ultra-sound, cellular (5G) and/or an Infra-red, etc.

Further, in some embodiments, the online platform 100 may be configured to retrieve (from a database such as databases 108) contact information associated with one or more legal guardians corresponding to the plurality of students. Further, in some embodiments, the online platform 100 may be configured to transmit the output file to one or more legal guardian devices. Further, the one or more legal guardian devices, in an instance, may be devices operated by one or more legal guardians associated with the plurality of students. For instance, the output file (that may include each student paper), in an instance, may automatically be sent to devices associated with the one or more legal guardians for review. For example, a “Monday quiz” may be automatically graded by the online platform 100 and transmitted to the one or more legal guardian devices associated with one or more legal guardians. Further, the one or more legal guardian devices, in an instance, may include devices such as, but not limited to, smartphones, smartwatches, TVs, Laptops, PCs, and so on.

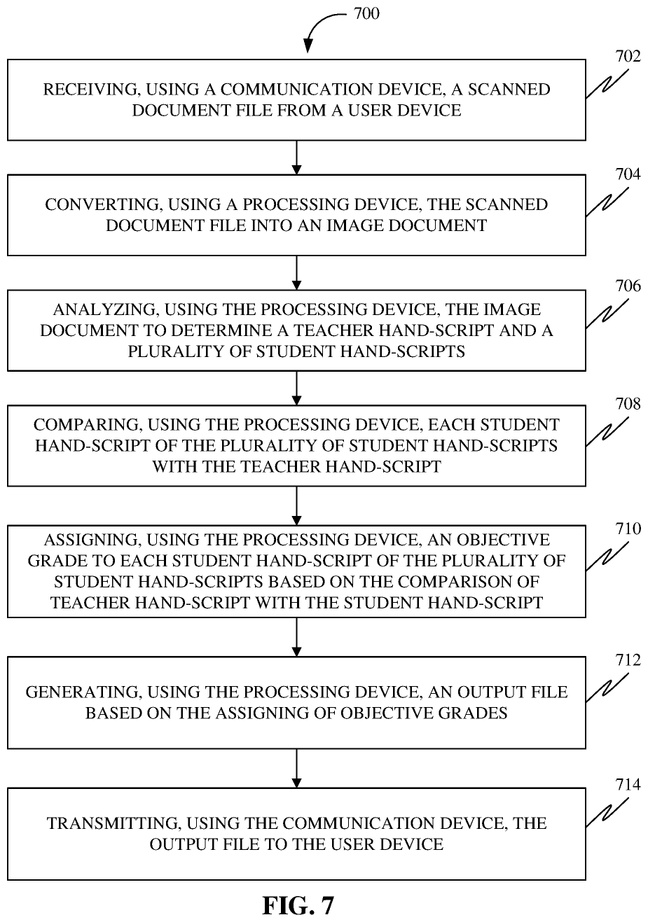

FIG. 7 is a flowchart of a method 700 to facilitate automatic and objective grading of handwritten sheets, in accordance with another embodiment. Accordingly, at 702, the method 700 may include a step of receiving, using a communication device, a scanned document file from a user device. Further, the scanned document file, in an instance, may be a digital file that may include a stack of multiple sheets in a digital form. For instance, the scanned document file may be a “.pdf” file that may include multiple pages associated with the stack of multiple sheets in the digital form. Further, the stack of multiple sheets, in an instance, may include (but not limited to) a plurality of student answer sheets, a one or more of unmarked sheets, a one or more of master answer sheets, etc. Further, the plurality of student answer sheets, in an instance, may be answer sheets corresponding to a plurality of students, which may need to be graded by a teacher. Further, the plurality of student answer sheets, in an instance, may include (but not limited to) handwritten textual content, and/or hand-drawn visual content (such as hand-drawn sketches/drawing), etc. Further, the one or more of unmarked sheets, in an instance, may be templates associated with question papers and/or quizzes that may include questions along with spaces for students to write answers. For instance, the unmarked sheet may include “complete a sentence” type questions providing space for a student to write answer corresponding to each question from available options. Further, in another instance, the unmarked sheet may include “fill in the blanks” type questions for students with a space to write answer corresponding to each question from available vocabulary words. Further, in some embodiments, the one or more unmarked sheets may include one or more section that may provide space for students to write an information associated with the student. For instance, the information may include (but not limited to) name, roll number, student ID number, etc. associated with the student. Further, the one or more master answer sheets, in an instance, may be a completely (and/or correctly) marked version of the unmarked sheets when filled with correct answers by the teacher. Further, the one or more master answer sheets, in an instance, may be used by the teacher as a reference in order to grade the plurality of student answer sheets. Further, the plurality of student answer sheets, in an instance, may be physically submitted by the plurality of students to the teacher. Further, the plurality of student answer sheets, the one or more unmarked sheets, and the one or more master answer sheets, in an instance, may be scanned by the teacher through a one or more of sensors that may be embedded within the user device (such as a hardware scanner, and/or a copy machine at school etc.). For instance, the teacher may use any form of scanner (such as a copy machine) at school and may scan the stack of multiple sheets in order to generate the scanned document file (such as a “.pdf” file). Further, the one or more sensors may include, but not limited to, light sensors, camera sensors, IR sensors, etc. Further, the user device, in an instance, may be an IoT (Internet of Things) based device that may be operated by the teacher in order to communicate with the online platform 100. For instance, the user device, in an instance, may include devices such as (but not limited to) smartphones, smartwatches, PCs, laptops, smart TVs, photocopy machines, etc. Further, in one embodiment, the stack of multiple sheets, in an instance, may be piled in a defined order by the teacher. For instance, the teacher may gather papers (such as the one or more unmarked sheets, the one or more master answer sheets, and/or the plurality of student answer sheets) and places the papers in an order such as first the one or more unmarked sheets, then the one or more master answer sheets, then the plurality of student answer sheets (in any order). Further, in some embodiments, the online platform 100, in an instance, may be configured to rearrange the stack of multiple sheets in a desired order if the stack of multiple sheets may be piled in random order by the teacher. For instance, the one or more unmarked sheet, the one or more master answer sheet, and/or the plurality of student answer sheets may include different markers that may be used to distinguish between different sheets.

Further, at 704, the method 700 may include a step of converting, using a processing device, the scanned document file into an image document. Accordingly, the online platform 100, in an instance, may be configured to convert the scanned document file (such as a “.pdf” file) into the image document for further processing (such as image analyses e.g., but not limited to, Handwritten Character Recognition, Optical Character Recognition, Intelligent word recognition, object recognition etc.).

Further, at 706, the method 700 may include a step of analyzing, using the processing device, the image document to determine a teacher hand-script and a plurality of student hand-scripts. Accordingly, the online platform 100, in an instance, may be configured to analyze the image document in a way such that any handwritten content (that may be referred to as markings) from the plurality of student answer sheets and the one or more master answer sheets may be extracted for grading. For instance, the online platform 100 may be configured to erase a background from the one or more master answer sheets and the plurality of student answer sheets leaving only markings and/or handwritten content behind (such as the teacher hand-script and/or the plurality of student hand-scripts). For instance, the online platform 100 may compare the one or more unmarked sheets (say background) with the one or more master answer sheets (say teacher images) in order to determine the teacher hand-script. The online platform 100, in an instance, may subtract the background from the teacher image and may leave remaining markings (and/or pixels) that may be referred to as the teacher hand-script. Further, the teacher hand-script, in an instance, may be assumed to be correct markings. Further, in another instance, the online platform 100 may compare the one or more unmarked sheets (say original image) with each student answer sheet of the plurality of student answer sheets, one at a time, removing the original image (and/or background) from each student answer sheet leaving only the student hand-script (and/or markings by the student, and/or the answers from the student). Further, the online platform 100, in an instance, may be configured to perform handwriting analyses (that may include processes such as image analyses e.g., but not limited to, Handwritten Character Recognition, Optical Character Recognition, Intelligent word recognition, object recognition, etc.) on the teacher hand-script and the plurality of student hand-scripts. Further, the handwriting analyses, in an instance, may use bounding of words (and/or “bounding boxes”) to keep the markings grouped. For instance, a word (such as “Cat”) may now be considered in a bounding box. If the word “cat” may not be bounded, then further processing may result in two separate words (such as “C”+“at”). Both would be correct as an answer, but when looking for “Cat”, “C”+“at” may not be correct. Further, in another instance, if an answer includes multiple words such as “the mouse fell,” the bounding boxes may already be around [the], [mouse], and [fell]. Further, the online platform 100, in an instance, may know that three characters may be grouped for the first word (the), five for the second string (mouse) and so on. Further, the bounding boxes, in an instance, may be important to remember where to place returned words (position and/or size). Further, the position and size, in an instance, may be retained. Further, once the bounding of words may be performed, the online platform 100 may isolate the markings into individual character images (and/or individual images). For instance, the word “Cat” may now be broken down to individual character images and may become “c,” “a,” and “t.” Further, once the markings may be isolated into individual character images, the online platform 100 may turn pixels into characters by using (for example) a simpler programming model for training and tracking. Further, the CNN model, in an instance, may be a Convolutional Neural Network model that may be widely used for image recognition. Further, in some embodiments, the online platform 100 may be configured to communicate with the other databases such as, but not limited to, NIST special database. Further, the NIST special database was produced by the US government (National Institute of Standards and Technology) for handprint document processing and/or OCR (optical character recognition) research. Further, in some embodiments, the online platform 100 may include morphological processing that may be configured to connect some broken character parts for improved recognition. Further, in some embodiments, the database may include dictionary words that may allow the online platform 100 to analyze the markings with a dictionary-based approach where recognition results may be compared with a set of possible words (from the dictionary).

Further, at 708, the method 700 may include a step of comparing, using the processing device, each student hand-script of the plurality of student hand-scripts with the teacher hand-script. Accordingly, the teacher hand-script and each student hand-script of the plurality of student hand-scripts, in an instance, may be compared by the online platform 100 in order to measure a level of similarity for each student hand-script with the teacher hand-script. Further, the level of similarity, in an instance, may reflect an extent of correctness for each student hand-script. Further, each word and/or markings of each student hand-script, in an instance, may be compared with corresponding word and/or markings of the teacher hand-script in order to measure the level of similarity between the two (the teacher hand-script and each student hand-script).

Further, at 710, the method 700 may include a step of assigning, using the processing device, an objective grade to each student hand-script of the plurality of student hand-scripts based on the comparison of teacher hand-script with the student hand-script. Accordingly, the online platform 100, in an instance, may be configured to assign an objective grade to each student hand-script based on the level of similarity with the teacher hand-script. Further, the objective grade corresponding to each student hand-script, in an instance, may be (but not limited to) a percentage number (%) that may reflect a percentage of “correct” words for each student hand-script. Further, the “correct” words, in an instance, may be words in the student hand-script that may match with corresponding words in the teacher hand-script. For instance, for a student, the objective grade may be 75% which may reflect that the student hand-script (associated with the student) include 75% of the words that may match with the teacher hand-script. Further, in some embodiments, the online platform 100, in an instance, may generate objective grading (numerical or alphabetical) based on the extent of correctness (e.g. depending on a number of errors, kind of errors, etc. within an answer). For instance, the online platform 100 may provide a partial point if at least part of the answer may be correct.

Further, at 712, the method 700 may include a step of generating, using the processing device, an output file based on the assigning of an objective grade. Accordingly, the output file, in an instance, may be a digital file which may include a grade page. Further, the grade page, in an instance, may be a listing of student names along with the grade corresponding to each student hand-script based on the level of similarity. Further, in some embodiments, the output file may include a sheet for the teacher. Further, the sheet, in an instance, may allow the teacher to see each question along with average score for that question. Further, the sheet, in an instance, may print the top 10% (for instance) questions with lowest aggregate score. Further, the teacher, in an instance, may use the sheet to review the quiz with the students. Further, allowing the teacher to review their own work may show what points in a lesson that were critical (hence, on the quiz) that had the highest lack of understanding. Further, in some embodiments, the output file, in an instance, may include a sheet for the students. The sheet, in an instance, may allow the students to see correct answers to missed questions for further review. For instance, if a student missed a question, the sheet may allow the student to see original (incorrect) answers along with the correct answer corresponding to the question.

Further, at 714, the method 700 may include a step of transmitting, using the communication device, the output file to the user device. Accordingly, the online platform 100, in an instance, may be configured to transmit the output file to the user device through a wireless transmitter. The wireless transmitter, in an instance, may transmit the output file over, but not limited to, a Wi-Fi, a Bluetooth, an electromagnetic waveform, ultra-sound, cellular (5G) and/or an Infra-red, etc.

Further, in some embodiments, the online platform 100 may be configured to retrieve (from a database such as databases 108) a contact information associated with one or more legal guardians corresponding to the plurality of students. Further, in some embodiments, the online platform 100 may be configured to transmit the output file to one or more legal guardian devices. Further, the one or more legal guardian devices, in an instance, may be devices operated by one or more legal guardians associated with the plurality of students. For instance, the output file (that may include each student paper), in an instance, may automatically be sent to devices associated with the one or more legal guardians for review. For example, a “Monday quiz” may be automatically graded by the online platform 100 and transmitted to the one or more legal guardian devices associated with one or more legal guardians. Further, the one or more legal guardian devices, in an instance, may include devices such as, but not limited to, smartphones, smartwatches, TVs, Laptops, PCs, and so on.

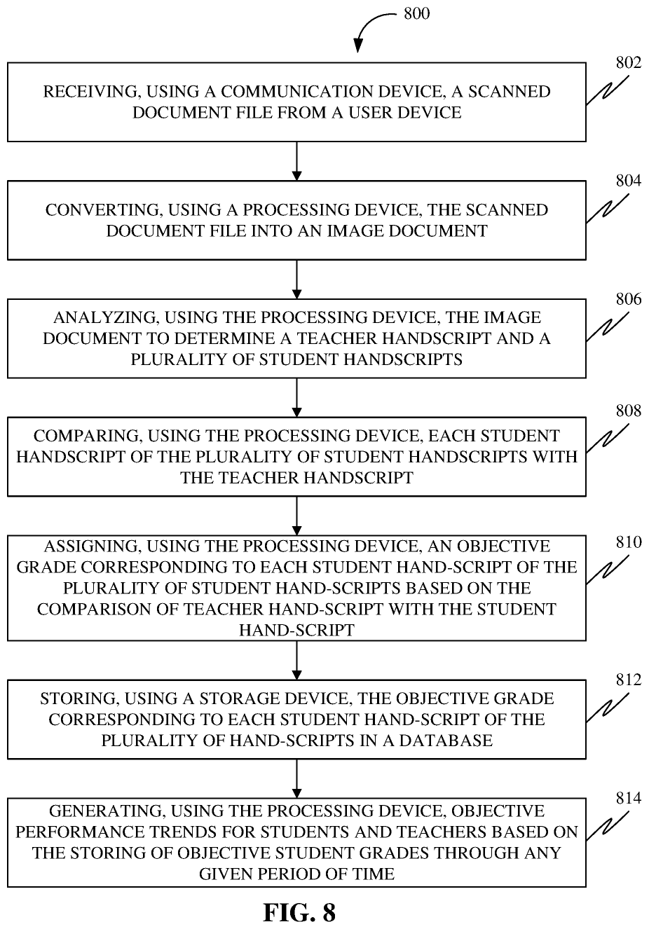

FIG. 8 is a flowchart of a method 800 to automate generating objective performance trend for teachers and/or students, in accordance with some embodiments. Accordingly, at 802, the method 800 may include a step of receiving, using a communication device, a scanned document file from a user device. Further, the scanned document file, in an instance, may be a digital file that may include a stack of multiple sheets in a digital form. For instance, the scanned document file may be a “.pdf” file that may include multiple pages associated with the stack of multiple sheets in the digital form. Further, the stack of multiple sheets, in an instance, may include (but not limited to) a plurality of student answer sheets, a one or more of unmarked sheets, a one or more of master answer sheets, etc. Further, the plurality of student answer sheets, in an instance, may be answer sheets corresponding to a plurality of students, which may need to be graded by a teacher. Further, the plurality of student answer sheets, in an instance, may include (but not limited to) handwritten textual content, and/or hand-drawn visual content (such as hand-drawn sketches/drawing), etc. Further, the one or more of unmarked sheets, in an instance, may be templates associated with question papers and/or quizzes that may include questions along with spaces for students to write answers. For instance, the unmarked sheet may include “complete a sentence” type questions providing space for a student to write answer corresponding to each question from available options. Further, in another instance, the unmarked sheet may include “fill in the blanks” type questions for students with a space to write answer corresponding to each question from available vocabulary words. Further, in some embodiments, the one or more unmarked sheets may include one or more section that may provide space for students to write an information associated with the student. For instance, the information may include (but not limited to) name, roll number, student ID number, etc. associated with the student. Further, the one or more master answer sheets, in an instance, may be a completely (and/or correctly) marked version of the unmarked sheets when filled with correct answers by the teacher. Further, the one or more master answer sheets, in an instance, may be used by the teacher as a reference in order to grade the plurality of student answer sheets. Further, the plurality of student answer sheets, in an instance, may be physically submitted by the plurality of students to the teacher. Further, the plurality of student answer sheets, the one or more unmarked sheets, and the one or more master answer sheets, in an instance, may be scanned by the teacher through a one or more of sensors that may be embedded within the user device (such as a hardware scanner, and/or a copy machine at school etc.). For instance, the teacher may use any form of scanner (such as a copy machine) at school and may scan the stack of multiple sheets in order to generate the scanned document file (such as a “.pdf” file). Further, the one or more sensors may include, but not limited to, light sensors, camera sensors, IR sensors, etc. Further, the user device, in an instance, may be an IoT (Internet of Things) based device that may be operated by the teacher in order to communicate with the online platform 100. For instance, the user device, in an instance, may include devices such as (but not limited to) smartphones, smartwatches, PCs, laptops, smart TVs, photocopy machines, etc. Further, in one embodiment, the stack of multiple sheets, in an instance, may be piled in a defined order by the teacher. For instance, the teacher may gather papers (such as the one or more unmarked sheets, the one or more master answer sheets, and/or the plurality of student answer sheets) and places the papers in an order such as first the one or more unmarked sheets, then the one or more master answer sheets, then the plurality of student answer sheets (in any order). Further, in some embodiments, the online platform 100, in an instance, may be configured to rearrange the stack of multiple sheets in a desired order if the stack of multiple sheets may be piled in random order by the teacher. For instance, the one or more unmarked sheet, the one or more master answer sheet, and/or the plurality of student answer sheets may include different markers that may be used to distinguish between different sheets.

Further, at 804, the method 800 may include a step of converting, using a processing device, the scanned document file into an image document. Accordingly, the online platform 100, in an instance, may be configured to convert the scanned document file (such as a “.pdf” file) into the image document for further processing (such as image analyses e.g., but not limited to, Handwritten Character Recognition, Optical Character Recognition, Intelligent word recognition, object recognition etc.).

Further, at 806, the method 800 may include a step of analyzing, using the processing device, the image document to determine a teacher hand-script and a plurality of student hand-scripts. Accordingly, the online platform 100, in an instance, may be configured to analyze the image document in a way such that any handwritten content (that may be referred to as markings) from the plurality of student answer sheets and the one or more master answer sheets may be extracted for grading. For instance, the online platform 100 may be configured to erase a background from the one or more master answer sheets and the plurality of student answer sheets leaving only markings and/or handwritten content behind (such as the teacher hand-script and/or the plurality of student hand-scripts). For instance, the online platform 100 may compare the one or more unmarked sheets (say background) with the one or more master answer sheets (say teacher images) in order to determine the teacher hand-script. The online platform 100, in an instance, may subtract the background from the teacher image and may leave remaining markings (and/or pixels) that may be referred to as the teacher hand-script. Further, the teacher hand-script, in an instance, may be assumed to be correct markings. Further, in another instance, the online platform 100 may compare the one or more unmarked sheets (say original image) with each student answer sheet of the plurality of student answer sheets, one at a time, removing the original image (and/or background) from each student answer sheet leaving only the student hand-script (and/or markings by the student, and/or the answers from the student). Further, the online platform 100, in an instance, may be configured to perform handwriting analyses (that may include processes such as image analyses e.g., but not limited to, Handwritten Character Recognition, Optical Character Recognition, Intelligent word recognition, object recognition, etc.) on the teacher hand-script and the plurality of student hand-scripts. Further, the handwriting analyses, in an instance, may use bounding of words (and/or “bounding boxes”) to keep the markings grouped. For instance, a word (such as “Cat”) may now be considered in a bounding box. If the word “cat” may not be bounded, then further processing may result in two separate words (such as “C”+“at”). Both would be correct as an answer, but when looking for “Cat”, “C”+“at” may not be correct. Further, in another instance, if an answer includes multiple words such as “the mouse fell,” the bounding boxes may already be around [the], [mouse], and [fell]. Further, the online platform 100, in an instance, may know that three characters may be grouped for the first word (the), five for the second string (mouse) and so on. Further, the bounding boxes, in an instance, may be important to remember where to place returned words (position and/or size). Further, the position and size, in an instance, may be retained. Further, once the bounding of words may be performed, the online platform 100 may isolate the markings into individual character images (and/or individual images). For instance, the word “Cat” may now be broken down to individual character images and may become “c,” “a,” and “t.” Further, once the markings may be isolated into individual character images, the online platform 100 may turn pixels into characters by using (for example) a simpler programming model for training and tracking. Further, the CNN model, in an instance, may be a Convolutional Neural Network model that may be widely used for image recognition. Further, in some embodiments, the online platform 100 may be configured to communicate with the other databases such as, but not limited to, NIST special database. Further, the NIST special database was produced by the US government (National Institute of Standards and Technology) for handprint document processing and/or OCR (optical character recognition) research. Further, in some embodiments, the online platform 100 may include morphological processing that may be configured to connect some broken character parts for improved recognition. Further, in some embodiments, the database may include dictionary words that may allow the online platform 100 to analyze the markings with a dictionary-based approach where recognition results may be compared with a set of possible words (from the dictionary).

Further, at 808, the method 800 may include a step of comparing, using the processing device, each student hand-script of the plurality of student hand-scripts with the teacher hand-script. Accordingly, the teacher hand-script and each student hand-script of the plurality of student hand-scripts, in an instance, may be compared by the online platform 100 in order to measure a level of similarity for each student hand-script with the teacher hand-script. Further, the level of similarity, in an instance, may reflect an extent of correctness for each student hand-script. Further, each word and/or markings of each student hand-script, in an instance, may be compared with corresponding word and/or markings of the teacher hand-script in order to measure the level of similarity between the two (the teacher hand-script and each student hand-script).

Further, at 810, the method 800 may include a step of assigning, using the processing device, an objective grade to each student hand-script of the plurality of student hand-scripts based on the comparison of teacher hand-script with the student hand-script. Accordingly, the online platform 100, in an instance, may be configured to assign an objective grade to each student hand-script based on the level of similarity with the teacher hand-script. Further, the objective grade corresponding to each student hand-script, in an instance, may be (but not limited to) a percentage number (%) that may reflect a percentage of “correct” words for each student hand-script. Further, the “correct” words, in an instance, may be words in the student hand-script that may match with corresponding words in the teacher hand-script. For instance, for a student, the objective grade may be 75% which may reflect that the student hand-script (associated with the student) include 75% of the words that may match with the teacher hand-script. Further, in some embodiments, the online platform 100, in an instance, may generate grading based on the extent of correctness (e.g. depending on a number of errors, kind of errors, etc. within an answer). For instance, the online platform 100 may provide a partial point if at least part of the answer may be correct.

Further, at 812, the method 800 may include a step of storing, using a storage device, the objective grade corresponding to each student hand-script of the plurality of hand-scripts in a database. Accordingly, the database (such as databases 108), in an instance, may be a storage device that may be configured to store the objective grades corresponding to each student hand-script of the plurality of students in an organized manner which may be accessed electronically through the user device. Further, the database, in some embodiments, may include any information and/or data that may be required by the online platform 100 in order to implement the method described in the present disclosure. Further, in some embodiments, a handwriting profile of the teacher and those of students may be linked with the hand-scripts to facilitate handwriting recognition. For instance, the online platform may retrieve a school schedule from the database to identify what class/subject/teacher may be associated with a particular hand-script containing scanned worksheets. Further, the online platform 100, in an instance, may be configured to identify the teacher and students associated with the hand-script and may retrieve their (teacher's and/or student's) handwriting profiles from the database.

Further, at 814, the method 800 may include a step of generating, using the processing device, objective performance trends for students and teachers based on the storing. Accordingly, the objective performance trend, in an instance, may be a visual representation (such as, but not limited to, graphical representation) of objective grades associated with the plurality of students for one or more subjects taught by one or more teachers. Further, the objective performance trends, in an instance, may be used by the students and teachers in order to track their respective performances. Further, the objective performance trends, in an instance, may provide incentives for students to perform better in one or more subjects. Further, the objective performance trends, in an instance, may provide incentives for teachers to improve teaching skills in one or more subjects. For instance, increased interest in using value-added estimates to identify high- and low-performing instructional staff (teachers) for special treatment, such as rewards and sanctions. For instance, the objective performance trend may include a sheet of top 10% (for instance) missed questions, which may aid the teacher while reviewing the test/quiz. Further, the online platform 100, in some embodiments, may be configured to transmit the objective performance trends to the user device through a wireless transmitter. The wireless transmitter, in an instance, may transmit the objective performance trend over, but not limited to, a Wi-Fi, a Bluetooth, an electromagnetic waveform, ultra-sound, cellular (5G) and/or an Infra-red, etc.

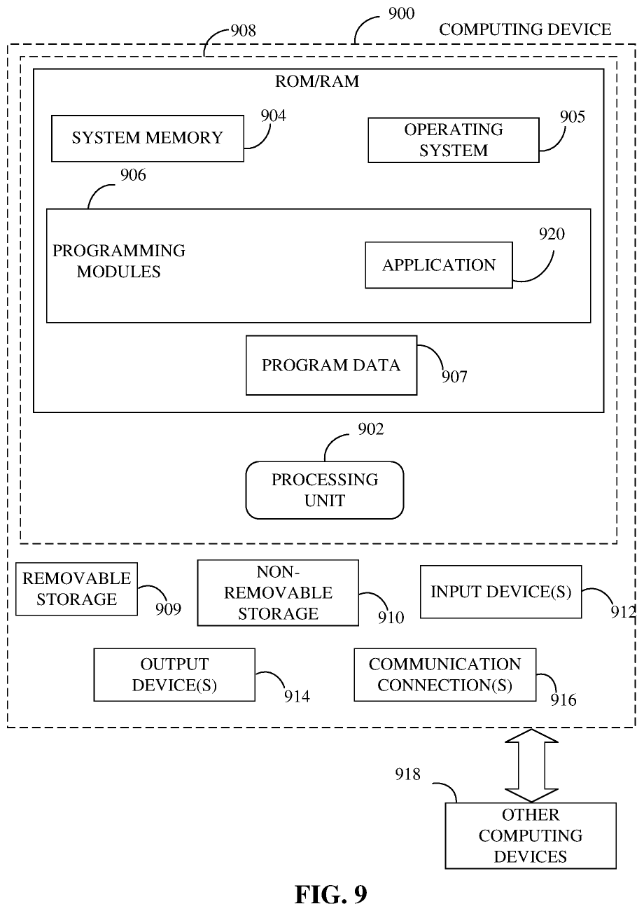

With reference to FIG. 9, a system consistent with an embodiment of the disclosure may include a computing device or cloud service, such as computing device 900. In a basic configuration, computing device 900 may include at least one processing unit 902 and a system memory 904. Depending on the configuration and type of computing device, system memory 904 may comprise, but is not limited to, volatile (e.g. random-access memory (RAM)), non-volatile (e.g. read-only memory (ROM)), flash memory, or any combination. System memory 904 may include operating system 905, one or more programming modules 906, and may include a program data 907. Operating system 905, for example, may be suitable for controlling computing device 900's operation. In one embodiment, programming modules 906 may include image-processing module, machine learning module. Furthermore, embodiments of the disclosure may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910. Computer storage media may include volatile and non-volatile, removable and non-removable media implemented in any method or technology for storage of information, such as computer-readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, a location sensor, a camera, a biometric sensor, etc. Output device(s) 914 such as a display, speakers, a printer, etc. may also be included. The aforementioned devices are examples and others may be used.

Computing device 900 may also contain a communication connection 916 that may allow device 900 to communicate with other computing devices 918, such as over a network in a distributed computing environment, for example, an intranet or the Internet. Communication connection 916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 904, including operating system 905. While executing on processing unit 902, programming modules 906 (e.g., application 920 such as a media player) may perform processes including, for example, one or more stages of methods, algorithms, systems, applications, servers, databases as described above. The aforementioned process is an example, and processing unit 902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating grading of handwritten sheets, wherein the method comprises:
receiving, using a communication device, at least one digital answer sheet associated with at least one student from at least one student device, wherein the at least one digital answer sheet is a digital representation of a student answer sheet, wherein the student answer sheet is marked by the at least one student;
receiving, using the communication device, at least one digital master sheet associated with at least one evaluator from at least one evaluator device, wherein the at least one digital master sheet is a digital representation of a correctly marked answer sheet, wherein the correctly marked answer sheet is marked by the at least one evaluator;
determining, using a processing device, at least one student hand-script based on analysis of the at least one digital answer sheet;
determining, using the processing device, at least one evaluator hand-script based on analysis of the at least one digital master sheet;
comparing, using the processing device, the at least one student hand-script with the at least one evaluator hand-script;
assigning, using the processing device, at least one grade to the at least one digital answer sheet based on the comparing;
storing, using a storage device, the at least one grade; and
transmitting, using the communication device, the at least one grade to at least one of the at least one student device, and the at least one evaluator device.

2. The method of claim 1, wherein the analysis of at least one of the at least one digital master sheet and the at least one digital answer sheet comprises:
retrieving, using the storage device, a digital template from a database, wherein the digital template is a digital representation of unmarked templates associated with at least one question paper;
comparing, using the processing device, the at least one digital master sheet with the digital template to determine the at least one evaluator hand-script; and
comparing, using the processing device, the at least one digital answer sheet with the digital template to determine the at least one student hand-script.

3. The method of claim 1 further comprises performing, using the processing device, a textual analysis on at least one of the at least one evaluator hand-script and the at least one student hand-script using convolutional neural network for handwritten content.

4. The method of claim 3, wherein the textual analysis comprises at least one of semantic analysis, syntactic analysis, and Intelligent Character Recognition.

5. The method of claim 1 further comprises performing, using the processing device, non-textual visual analysis on the at least one evaluator hand-script and the at least one student hand-script using convolutional neural network for non-textual visual content.

6. The method of claim 5, wherein the non-textual visual analysis comprises object recognition.

7. The method of claim 1, wherein the method further comprising:
generating, using the processing device, performance trend data associated with at least one of the at least one student and the at least one evaluator based on the at least one grade; and
transmitting, using the communication device, the performance trend data to at least one of the at least one student device and the at least one evaluator device.

8. The method of claim 7, wherein the performance trend data is a visual representation of the at least one grade associated with the at least one student for at least one subject taught by the at least one evaluator.

9. The method of claim 1 further comprises analyzing, using the processing device, the at least one digital answer sheet to extract student data corresponding to the at least one student, wherein the student data comprises at least one of a student name, a student identity number, a student roll number, and a student standard;

10. The method of claim 9, wherein the transmitting of the at least one grade to at least one of the at least one student device and the at least one evaluator device is based on the student data.

11. A system for facilitating grading of handwritten sheets, wherein the system comprises:
a communication device configured for:
receiving at least one digital answer sheet associated with at least one student from at least one student device, wherein the at least one digital answer sheet is a digital representation of a student answer sheet, wherein the student answer sheet is marked by the at least one student;
receiving at least one digital master sheet associated with at least one evaluator from at least one evaluator device, wherein the at least one digital master sheet is a digital representation of a correctly marked answer sheet, wherein the correctly marked answer sheet is marked by the at least one evaluator; and
transmitting at least one grade to at least one of the at least one student device, and the at least one evaluator device.
a processing device configured for:
determining at least one student hand-script based on analysis of the at least one digital answer sheet;
determining at least one evaluator hand-script based on analysis of the at least one digital master sheet;
comparing the at least one student hand-script with the at least one evaluator hand-script; and
assigning the at least one grade to the at least one digital answer sheet based on the comparing; and
a storage device configured for storing the at least one grade.

12. The system of claim 11, wherein the storage device is further configured for retrieving a digital template from a database, wherein the digital template is a digital representation of unmarked templates associated with at least one question paper; and
the processing device is further configured for:
comparing the at least one digital master sheet with the digital template to determine the at least one evaluator hand-script; and
comparing the at least one digital answer sheet with the digital template to determine the at least one student hand-script.

13. The system of claim 11, wherein the processing device is further configured for performing a textual analysis on at least one of the at least one evaluator hand-script and the at least one student hand-script using convolutional neural network for handwritten content.

14. The system of claim 13, wherein the textual analysis comprises at least one of semantic analysis, syntactic analysis, and Intelligent Character Recognition.

15. The system of claim 11, wherein the processing device is further configured for performing non-textual visual analysis on the at least one evaluator hand-script and the at least one student hand-script using convolutional neural network for non-textual visual content.

16. The system of claim 15, wherein the non-textual visual analysis comprises object recognition.

17. The system of claim 11, wherein the processing device is further configured for generating performance trend data associated with at least one of the at least one student and the at least one evaluator based on the at least one grade; and
the communication device is further configured for transmitting the performance trend data to at least one of the at least one student device and the at least one evaluator device.

18. The system of claim 17, wherein the performance trend data is a visual representation of the at least one grade associated with the at least one student for at least one subject taught by the at least one evaluator.

19. The system of claim 11, wherein the processing device is further configured for analyzing the at least one digital answer sheet to extract student data corresponding to the at least one student, wherein the student data comprises at least one of a student name, a student identity number, a student roll number, and a student standard;

20. The system of claim 19, wherein the transmitting of the at least one grade to at least one of the at least one student device and the at least one evaluator device is based on the student data.
